(19) United States
(12) Patent Application Publication
(10) Pub. No.: US 2007/0153442 A1
(43) Pub. Date: Jul. 5, 2007

(54) Circuit Arrangement with Explosion Protection

(76) Inventors: Klaus Guenter, Aichhalden (DE); Albert Woehrle, Aichhalden (DE)

Correspondence Address: FAY KAPLUN & MARCIN, LLP, 15O BROADWAY, SUITE 702, NEW YORK, NY, 10038, US

(21) Appl. No.: 11/613,416

(22) Filed: Dec. 20, 2006

Related U.S. Application Data
(60) Provisional application No. 60/754,233, filed on Dec. 27, 2005.

(30) Foreign Application Priority Data
Dec. 27, 2005 (DE) DE102005062422.7

(51) Int. Cl. H02H 3/08

(52) U.S. Cl. 361/93.1

(57) ABSTRACT

A circuit arrangement for a field device includes an input, an output and a current-limiting element. The circuit arrangement is designed to transmit a useful signal along a useful-signal path from the input to the output. The input and the output are galvanically separated from each other. The current-limiting element is arranged outside the useful-signal path.

### RELATED APPLICATIONS

This application claims the benefit of the filing date of U.S. Provisional Patent Application Ser. No. 60/754,233 filed Dec. 27, 2005 and of German Patent Application Serial No. 10 2005 062 422.7 filed Dec. 27, 2005, the disclosures of which are hereby incorporated herein by reference.

### FIELD OF THE INVENTION

The present invention relates to the general technical field of metrology. In particular, the present invention relates to a circuit arrangement, a field device, and a method for operating a circuit arrangement, in which arrangement, device and method a current-limiting element is arranged outside a useful-signal path.

### BACKGROUND INFORMATION

In metrology it is common for so-called field devices, which convert process values to electrical signals, to be connected to feed devices or evaluation devices by way of bus systems. In this way the measuring signals that have been picked up by the field devices can be transmitted to the feed devices over long distances. The so-called HART® bus standard provides a technique, which is common today, for connecting field devices to feed devices. By way of the HART® bus standard it is possible to transmit measured values that have been determined by a field device to a feed device, with such transmission being either analogue or digital. However, feed devices and evaluation devices can also be separate devices, wherein, in the case of data transmission, the data is transmitted to the evaluation device. In the case of a digital bus, such transmission can be bidirectional.

For the setting of parameters, also called parameterisation, of a field device it may be necessary that a programming device is to be connected to the field device. Since wiring between a field device and a feed device is usually fixed, i.e. it can be detached only with considerable difficulties, it is possible, for the parameterisation, setting of parameters, or scanning of values from the field device, to connect a parameterisation arrangement or device in parallel with the existing fix-connection bus system and in this way to access individual values or parameters of the field device.

During coupling of a programming device to the field device two current circuits are interconnected. Due to different potentials between the current circuits it is possible for charge equalisation between the current circuits to occur. Such charge equalisation can be prevented by direct-current suppression.

However, direct-current suppression cannot prevent the occurrence of high short-term current peaks. Such high current peaks can result in damage to the coupled circuits.

Furthermore, the current peaks can result in an ignition-triggerable or incendive spark, which is to be avoided in particular if the coupling of the two circuits is to be used in a potentially explosive environment.

Installing a resistor in a connection line of the parameterisation device to the HARTS bus nowadays prevents excessive current flow, which can otherwise result in an ignition-triggerable spark. By the resistor the current is reduced to a non-hazardous extent so that sparking can be prevented. However, the signal quality is negatively affected by a current-limiting resistor.

### SUMMARY OF THE INVENTION

According to an exemplary embodiment a circuit arrangement or assembly for a field device is provided, wherein the circuit arrangement comprises an input, an output, and at least one current-limiting element, wherein the circuit arrangement is designed to transfer a wanted- or useful-signal along a useful-signal path from the input to the output, wherein the input and the output are separated from each other by direct-current separation or direct-current suppression, and wherein the at least one current-limiting element is arranged outside the useful-signal path. The at least one current-limiting element may be a short-circuit current-limiting element which reduces the extent of a current that flows during a short circuit to a permissible level. In particular, within the context of this application the term “direct-current suppression” refers to a situation where for charge carriers there is essentially no way to flow from one current circuit to another (directly adjacent) current circuit.

The at least one current-limiting element may reduce a current such that the circuit arrangement, in particular part of the circuit arrangement, may be operated in a potentially explosive environment. The current-limiting element may therefore provide explosion protection.

According to one exemplary embodiment a parameterisation arrangement with explosion protection is provided, which parameterisation arrangement comprises an input and an output. Furthermore, the parameterisation arrangement comprises at least one current-limiting element. The parameterisation arrangement is designed to transmit a useful signal along a signal path from the input to the output, wherein the input and the output are separated by direct-current suppression or direct-current separation (see above for direct-current separation), and wherein the at least one current-limiting element is arranged outside the useful-signal path. In the context of this application parameterisation may in particular relate to the setting of parameters, e.g. a parameterisation arrangement or a parameterisation assembly may be a arrangement or assembly which is suitable for setting parameters of another device, e.g. a field device.

By the at least one current-limiting element part of the circuit arrangement may be used in an explosion-protected environment. The part of the circuit arrangement that extends in an explosion-protected environment may be an output or an output line of the circuit arrangement, which output line is connected to the output.

Limiting the short-circuit current may prevent an ignition spark from arising as a result of excessive current, during coupling of the circuit arrangement, for example to a bus. In this process an undesired current may flow, for example if the bus coupling connections accidentally touch each other.

By arranging the at least one current-limiting element outside the useful-signal path, a situation may be avoided in which at least one current-limiting element influences the signal during transmission of the useful signal in a main path. Nevertheless, if a short circuit occurs, the at least one current-limiting element can limit the extent of this short-circuit current so that it is adequately small.

Direct-current separation of the input from the output of the circuit arrangement may concretely decouple the output from the input. Different potential levels between the input and the output can consequently essentially not equalise, as a result of which the rise of undesirable currents and the generation of sparks may also be prevented or reduced. Furthermore, direct-current separation or direct-current suppression may be used for filtering direct-current signals. Most of the time, direct-current separation may form a barrier to a direct-current signal. It may thus be possible to avoid a situation in which direct-current signals propagate by way of direct-current separation.

Measuring devices are frequently used in potentially explosive environments. If, for example, gas pressures or liquid levels of flammable liquids are to be measured with measuring devices, there may be an increased danger of explosion because the potentially explosive materials may spread in an uncontrolled way and may easily ignite.

In order to reduce the danger of explosion, so-called explosion protection classes have been determined which classify the danger of work to be carried out. These explosion protection classes regulate limiting values such as, for example, maximum permissible electrical voltages or currents that may occur in the context of measuring in potentially explosive environments. Excessive currents, for example short-circuit currents, may create spark-over; likewise, an excessive voltage differential may result in spark-over. In the context of potentially explosive materials, such as for example gases, the sparks may cause explosions. However, the danger of spark-over may be reduced by direct-current separation or of at least one current-limiting element.

According to an exemplary embodiment of the invention a field device with a circuit arrangement with the above-described features is created. In the context of this application the term “field device” also refers to a measuring device such as a pressure measuring device or a fill level measuring device. According to a further exemplary embodiment, in particular a measuring device with a parameterisation arrangement or a circuit arrangement is stated, wherein the circuit arrangement comprises the features stated above. A measuring device that comprises a circuit arrangement may make it possible for an inexpensive parameterisation device to be used for the parameterisation of the measuring device. However, a parmeterisation device that may be connected to a measuring device with the circuit arrangement may need not itself comprise direct-current separation for decoupling two current circuits. A measuring device with the circuit arrangement which circuit arrangement can be designed as a parameterisation adaptation arrangement may (on one input) be used for connecting a parameterisation device and may provide a corresponding interface. The output of the circuit arrangement may be firmly connected to a measuring bus of the measuring device. In this setup the circuit arrangement may be arranged in the measuring device. Just as the output may be matched to a potentially explosive environment, the input of the circuit arrangement may also be adapted for use in a potentially explosive environment.

According to an exemplary embodiment a method for operating a circuit arrangement for a field device is provided, wherein the method comprises transmitting a useful signal along a useful-signal path from an input to an output of the circuit arrangement; separation of the input from the output by using a direct-current suppression; and arranging of at least one current-limiting element in the circuit arrangement and outside the useful-signal path.

Exemplary embodiments of the invention can be implemented both by a computer program, i.e. software, and by one or several special electrical circuits, i.e. in hardware, or in any hybrid form, i.e. by software components and hardware components.

Because the at least one current-limiting element may be wired outside the useful signal, e.g. the at least one current-limiting element is arranged outside the path on which the useful signal is transmitted, influencing the useful signal by the current-limiting element during signal transmission of the useful signal may be prevented.

Because it may be possible to avoid a situation where in a clamping circuit a resistor that can be used for current reduction or current limitation is located in the useful-signal path, it may also be possible to avoid negatively influencing a useful signal that is transmitted through the resistor.

According to a further exemplary embodiment a circuit arrangement is provided, wherein the output of the circuit arrangement is designed to be connected to a bus. By such a design of the output a disconnectable connection may be provided between a circuit arrangement and a bus. During measuring operations, the circuit arrangement may be coupled to the bus and/or decoupled from the bus by an output that is designed to be connected to a bus. With an output of the circuit arrangement, which output is designed to be connected to the bus, any interference with a measuring process or with some other transmission on the bus can be reduced.

According to another exemplary embodiment a circuit arrangement is provided whose output is a HART® bus or an I²C bus. By designing the output as a HART® bus or I²C bus or field bus it may be possible for the circuit arrangement to flexibly connect to commonly used measuring bus systems.

According to a further exemplary embodiment a circuit arrangement is provided, wherein the output of the circuit arrangement is designed so as to comprise two wires, and/or for connection of a two-wire bus. In this context the term “two-wire” may mean that useful information is transmitted by way of two signal lines. The output itself can comprise several connections (including more than two connections).

In metrology two-wire connections frequently occur. Measuring signals may be transmitted by way of such a two-wire connection, which may be formed as a bus system. Parameterisation or configuration of field devices may also take place by way of this two-wire line. Field devices without an operator terminal of their own for configuration are possibly connected to a programming device by way of an externally connected circuit arrangement. In this arrangement the two-wire design of the output or of the interface of the circuit arrangement may have advantages.

According to a further exemplary embodiment a circuit arrangement is provided, wherein at least part of the circuit arrangement is designed for use in a potentially explosive environment. If the circuit arrangement itself is not operated in the potentially explosive environment, it may be possible that at least the output, in particular a line connected to the output, may be operated in a potentially explosive environment. In order to be able to operate a line in a potentially explosive environment by the circuit arrangement, the circuit arrangement may comprise a protective device. To this effect the circuit arrangement, in particular an output stage of the circuit arrangement, may be designed to render an output, in particular a line connected to an output, operable in a potentially explosive environment.

Potentially explosive environments can be specially classified safety regions in which there is a particular danger of explosion as a result of the type of measuring materials, and/or materials which are measured, used.

According to a further exemplary embodiment a circuit arrangement is provided whose input is a universal serial bus (USB) connection or an RS232 connection.

PCs or laptops or notebooks can be used for parameterisation. The provision of USB or RS232 connections may be advantageous for connection to the interfaces of such computers, as well as for connection to the interface of a PDA (personal digital assistant) or of other parameterisation devices. Designing the circuit arrangement by an interface that is compatible with the USB standard or the RS232 standard may make it possible to connect a computer or a programming device to the circuit arrangement. In conjunction with a correspondingly matched output, the circuit arrangement may thus provide an interface converter function, which may convert the signals of the interfaces among each other.

According to a further exemplary embodiment, a circuit arrangement is provided, in which the useful signal is a parameterisation signal for at least one field device, which may, for example, be a fill level measuring device or a pressure measuring device. Matching the parameterisation device to a fill level measuring device or a pressure measuring device may make it possible to parameterise a fill level measuring device or a pressure measuring device.

According to yet another exemplary embodiment, a circuit arrangement is provided in which direct-current suppression is generated by a capacity (for example by a capacitor, a capacitor bank or parasitic capacitance). The term capacity in particular refers to a capacitor. A capacitor may be a barrier to a direct-current signal, while alternating signals of a certain (adequately high) frequency may propagate across this barrier.

According to a further exemplary embodiment a circuit arrangement is provided in which the at least one current-limiting element is a resistor, in particular a resistor with an ohmic component, furthermore in particular an essentially purely ohmic resistor. The resistor may delay the discharge of a capacitance. The charge of the capacity cannot be released through the resistance limiter in a very short time. Discharge of the capacity may be spread over an extended time. The discharge currents that flow in this process may be correspondingly small in order to meet the requirements of a device suitable to provide explosion protection. Incidents of spark-over may thus be avoided.

In addition to the resistor, for example Zener diodes may ensure voltage limitation and thus may ensure short-circuit current limitation or discharge current limitation. In the case of a short circuit, small currents that are not dangerous can thus flow. Due to the small currents the circuit arrangement can be connected to a bus that leads to the potentially explosive environment. In this arrangement the summation of currents of interconnected devices should be smaller than the permissible current at the highest voltage in the circuit.

A voltage in a HART® bus system can, for example, be a voltage of 30 volt. In the case of a short circuit, a short-circuit current of, for example, 131 mA may then flow. The use of resistors together with Zener diodes, whose disruptive discharge voltage is 6 volt, may reduce the short-circuit current.

According to a further exemplary embodiment, a resistor is arranged between the useful-signal path and a reference point, for example an electrical reference potential, such as the mass potential or the supply voltage, of the circuit arrangement. In this way the path of a short-circuit current may be determined. The short-circuit current may be led away so that it is separate from the useful-signal path. For example, the path of the useful signal may be led to a mass potential via the resistor.

According to a further exemplary embodiment, a circuit arrangement is provided, wherein the useful-signal path comprises at least one diode. If several diodes are used, the diodes can be arranged in a series circuit. By way of their forward voltage the diodes may determine a working point of the transmission.

The use of three diodes or more may reduce the failure probability of the function of the diodes. In this way, the requirements of devices that are to be operated in a potentially explosive environment may be met. For, even if two diodes should fail, the blocking function of the diodes may be maintained by the diode that is intact.

According to exemplary embodiments a circuit arrangement, a field device and a method for operating a circuit arrangement are provided which may provide an interference-immune circuit arrangement for a field device.

This need may be met by a circuit arrangement, a field device and a method for operating a circuit arrangement with the features according to the independent claims.

Many improvements of the invention have been described with reference to the parameterisation arrangement or the circuit arrangement. These designs also apply to the method for operating the circuit arrangement.

### SHORT DESCRIPTION OF THE DRAWINGS

Below, exemplary embodiments of the present invention are described with reference to the figures:

FIG. 1 shows a functional block diagram of a measuring arrangement with a connected parameterisation arrangement according to an exemplary embodiment of the present invention.

FIG. 2 shows a detailed functional block diagram of a measuring arrangement with a connected parameterisation arrangement according to an exemplary embodiment of the present invention.

FIG. 3 shows a circuit diagram of an explosion protection circuit for coupling a useful signal to a measuring bus according to an exemplary embodiment of the present invention.

### DETAILED DESCRIPTION

The illustrations in the figures are diagrammatic and not to scale. In the following description of FIGS. 1 to 3 the same reference signs are used for identical or corresponding elements.

FIG. 1 shows a functional block diagram of a measuring arrangement with a connected parameterisation arrangement according to an exemplary embodiment of the present invention.

The field device 101 or measuring device 101 (for example a fill level measuring device or a pressure measuring device) is connected to a feed device 102 and/or an evaluation- or display device 102 by way of a measuring device bus 103, for example a field bus, HART® bus or VBUS. By way of the measuring bus 103, the field device 101 and the feed device 102 exchange bi-directional information, such as for example measured values.

For the programming or parameterisation of the field device 101 an additional device can be connected to the measuring device bus 103. In FIG. 1 the parameterisation arrangement 105 is connected by way of the connection 104, which is disconnectably connected to the measuring device bus 103. In this arrangement the connection 104 is routed at least partly in an environment to which the requirements of an explosion protection class apply. By way of the disconnectable connection the parameterisation arrangement 105 can be connected or unclamped at any time. The communication between the measuring device 101 and the feed device 102 is not influenced by clamping or unclamping of the connection 104.

When connecting or disconnecting the connection 104 to/from the bus 103, in particular as a result of unintended touching of lines, spark-over can occur, which must be avoided in particular in potentially explosive environments, e.g. areas which are exposed to explosive conditions. To prevent dangerous sparks, which could trigger an explosion, from occurring when coupling or uncoupling the connection 104 to the measuring device bus 103, the parameterisation arrangement 105 comprises an explosion protection circuit 106. The explosion protection circuit 106 concretely ensures physical matching of the matching signals of the parameterisation arrangement 105 to the signals of the measuring bus 103, and also ensures adequate protective measures for using at least part of the parameterisation arrangement 105 or the connection 104 in a potentially explosive environment.

The parameterisation functions are provided by a parameterisation device (not shown in FIG. 1). To this effect the parameterisation arrangement 105 provides a connection 107 for a parameterisation device, for example a PC or a PDA with corresponding software. Connection of the external parameterisation device to the interface 107 can, for example, take place by way of a USB interface or by way of an RS232 interface.

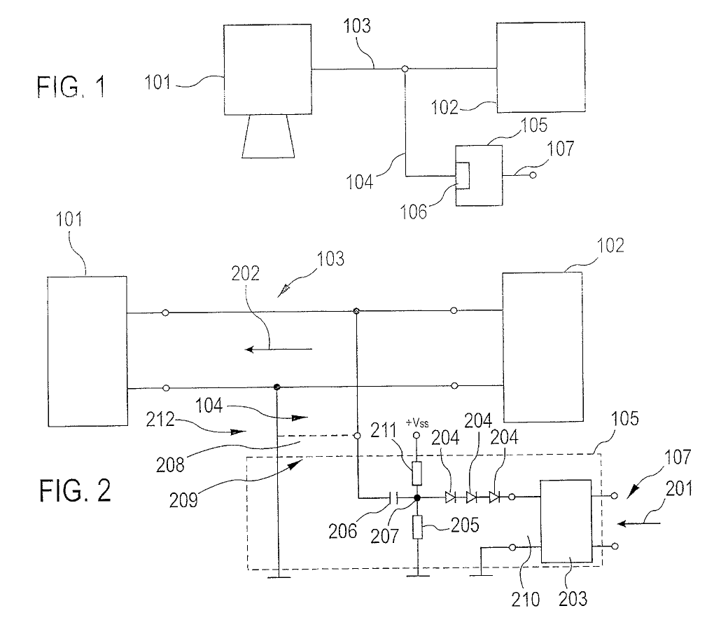

FIG. 2 shows a detailed functional block diagram of a measuring arrangement with a connected parameterisation arrangement according to an exemplary embodiment of the present invention.

FIG. 2 again shows the field device 101, which is connected to the feed device 102 by way of the measuring device bus 103. In FIG. 2 the measuring device bus 103 is shown as a two-wire bus. It can thus be a HART® bus. By using the parameterisation arrangement 105 or the circuit arrangement 105 the useful parameterisation information 201 is to be coupled to the measuring device bus 103 as a useful parameterisation signal 202 and is to be conveyed to the field device 101 for parameterisation purposes. To this effect the useful parameterisation signal 201 is fed to the input 107 of the parameterisation arrangement 105 and is conveyed to the measuring device bus 103 by way of the output 209 of the parameterisation arrangement 105. FIG. 2 shows only two useful data connections of the interface 107. The interface 107 can comprise further connections such as a power supply line.

While FIG. 2 only shows the flow of useful signals or work signals from the input 107 to the output 209, a useful-signal flow, for example a feedback signal from the field device, can also take place in the opposite direction. A parameterisation device is connected to the input 107 of the parameterisation arrangement 105. By an interface conversion device 203 the input signal is converted to a bus signal at the output 210 of the interface conversion device 203. The interface conversion device 203 comprises galvanic separation (not shown in FIG. 2).

The parameterisation arrangement 105 is coupled to the bus line 103 by a line pair 104. The line pair 104 is routed at least in part in a potentially explosive environment 212.

The first current-limiting element 205, the second current-limiting element 211 and the three diodes 204 are used to ensure current-limit values to make it possible to operate part of the parameterisation arrangement 105 in a potentially explosive environment, in particular in order to make it possible to operate the line 104 in a potentially explosive environment. The first current-limiting element 205, the second current-limiting element 211 and the three diodes 204 can carry out the functions of a explosion protection circuit 106. The current-limiting elements 205, 211 and the diodes 204 protect the direct-current suppression 206 or the direct-current separation 206 or the capacitor 206. In the case of a fault occurring, the capacitor 206 can become low-resistant. This means that the capacitor lets direct current flow through, and only provides ohmic resistance to the direct current.

At the output 210 of the interface conversion device 203, diodes 204 are located in the useful-signal path. Although FIG. 1 shows three diodes 204, any desired number of diodes can be used. The number of diodes depends on the selected protection level. If three diodes 204 are used, two diodes 204 can fail without this resulting in the loss of the function of the diodes 204. In this context, fail of a diode 204 means that the blocking function of the diode 204 is lost and the diode 204 becomes conductive with low resistance.

The diodes 204 are connected in series. The cathode of a first diode 204 is connected to the output 210 of the interface conversion circuit or voltage conversion device 203. The cathode of a second diode 204 is connected to the anode of the first diode 204. On the anode of the second diode 204 the short-circuit current-limiting resistor 205 and the direct-current separation element 206 and/or the capacitor 206 are connected. The current-limiting resistor 205 connects the potential node 207 to the mass potential. Also at the connection point 207 the positive supply voltage +Vss is connected by way of the resistor 211. The positive supply voltage +Vss changes the two diodes 204 to a conductive state so that a useful signal that emanates from the output 210 of the voltage conversion device 203 is conveyed to the node 207. In the case shown in FIG. 2 the diodes are conductive because +Vss is connected to the node 207 by way of the resistor 211. Not shown in FIG. 2 is a switch, in particular a transistor, which can be arranged between +Vss and the resistor 211, as a result of which the diodes 204 only become conductive if the switch is switched on and thus +Vss is present at the node 207. By the switch, for example the diodes 204 can be brought to a conductive state when a signal is to be transmitted to the bus.

By using the direct-current separation 206, direct-current fractions are filtered out of the useful parameterisation signal, as a result of which, in particular, above all a direct current is prevented from flowing from the bus to the parameterisation arrangement 105. On the way from the output 210 via the diodes 204 and the direct-current separation 206, the useful parameterisation signal bypasses the resistor 205 and the resistor 211. As a result of this the current-limiting resistor 205 cannot interfere with the useful parameterisation signal. Interference with the useful parameterisation signal is thus prevented. By way of the output 209 of the parameterisation arrangement 105 the useful parameterisation signal 202 is conveyed to the measuring device bus 103 or to the field device 101.

In addition to the state of signal transmission in an interference-free scenario, FIG. 2 shows the malfunction case of a short circuit, in dashed lines, by the short circuit 208. In the case of a short circuit 208 discharge of the capacitor 206 takes place by way of the mass line.

A capacitor is deemed to be an unsafe component for the purpose of explosion protection. A situation can arise in which in the case of a fault the capacitor 206 becomes low-resistant. A current caused by +Vss could thus flow, by way of the line 104, to the bus 103 or to the short circuit 208.

In the case of a short circuit the capacity 206 discharges via the resistor 205. The resistor 205 also limits the short-circuit current, which occurs as a discharge current of the capacity 206, to a small current that is permissible in a potentially explosive environment. In this way the parameterisation arrangement 105 or the interface converter 105 can also be connected to lines that lead in the potentially explosive environment.

In the case of a short circuit 208 and a low-resistant capacitor 206 it is also possible for an increased current flow to occur through the potentially explosive environment 212, from +Vss via the resistor 211, the capacitor 206 and the short-circuit 208 to mass. This current is kept adequately small by the resistor 211 so as not to exceed the value permissible for a potentially explosive environment. Consequently the circuit arrangement 105 is adapted for operation in a potentially explosive environment 212.

There is triple safeguarding against failure of the diodes 204. An increase in the number of diodes 204 increases failure safety. The diodes prevent current from flowing from the output 310 of the interface conversion circuit 203 via the direct-current separation 206.

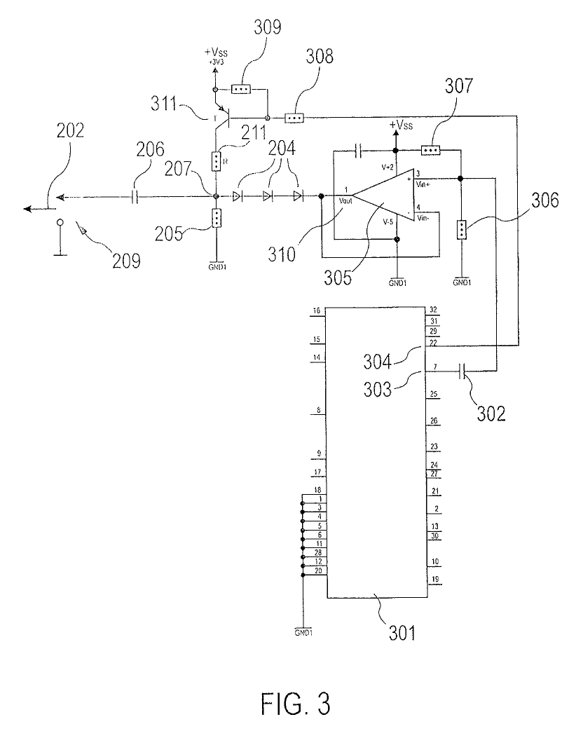

FIG. 3 shows a circuit diagram of an explosion protection circuit for coupling a useful signal to a measuring bus, according to an exemplary embodiment of the present invention.

At its output 303 the HART® bus driver module 301 provides an output signal that corresponds to the HART® bus protocol. This output signal is conveyed to the positive input of the operational amplifier 305 by way of the capacity 302.

The signal to be transmitted, which signal is provided at the output 303 of the module 301, is a parameterisation signal in the HART® bus format. At this point the signal is FSK (frequency shift keying) modulated. In other words the signal is essentially free of direct-current fractions.

The operational amplifier 305 is connected as a driver module in voltage follower switching. In this switching type, impedance matching of a high impedance at the input of the operational amplifier 305 takes place with a low impedance at the output of the operational amplifier 305. As a result of the high input impedance of the operational amplifier 305 the output 303 of the integrated circuit arrangement 301 is only subjected to light loads.

By way of the resistors 306 and 307 in voltage divider switching, which resistors 306 and 307 are also connected to the positive input of the operational amplifier 305, a fixed direct-voltage level is provided to the positive input of the operational amplifier 305. The capacitor 302 filters direct-current fractions from the FSK signal that has been provided at the output 303. The alternating-current signal is modulated upon the direct-voltage signal on the positive input of the operational amplifier 305, which direct-voltage signal has been generated by the voltage dividers 307 and 306. At the output 310 of the operational amplifier 305 a signal is available onto which the useful signal has been modulated.

Further processing of this signal then depends on the state of the transistor 311. By way of the pullup resistor 309 the base of the transistor 311 has been determined to a value that depends on the supply voltage +Vss. By way of the resistor 308 the base of the transistor 311 and a connection of the resistor 309 are connected to the output 304 of the module 301. By way of the output 304 a switching signal of a microcontroller can be applied, and it can be determined whether the useful signal is to be switched through to the output 209. In order to prevent, in the case of a fault, too large a current from flowing between +Vss and mass via the capacitor 206 and parts of the line 104, the resistor 211 limits the current.

In particular two cases can occur.

If in a first case a positive level is present at the output 304, the transistor 311 blocks. Consequently the potential point 207 is present at mass potential, via the resistor 205. The anode of one of the three diodes 204 is connected to the point 207. The diodes 204 are connected in series. Because of the negative signal level on point 207 in relation to output 310 the diodes 204 block. Transmission from the output 310 of the operational amplifier 305 by way of the diodes 204 is not possible because no current can flow via the diodes, upon which current the signal of the output 310 of the operational amplifier 301 can be modulated. It is thus not possible for an output signal or a useful signal 202 to be present at the output 209.

In a second case a negative signal level is provided at the output 304. By providing this signal level, useful signal transmission by way of the parameterisation arrangement is ought to be possible. If a negative signal level is present at the output 304, this negative signal level is conveyed by way of the resistor 308 to the base of the transistor 311, as a result of which the transistor 311 becomes conductive. In this way the supply voltage +Vss can be conveyed to the node 207 by way of the transistor 311 and by way of the resistor that is connected to the collector of the transistor 311. As a result of the now positive voltage at the node 207 in relation to output 310, the three diodes 204 are brought to a conductive state if the total disruptive discharge voltage of the diodes 204 is exceeded. In this way the signal that is present at the output 310 of the operational amplifier 305 by way of the output 303, the capacity 302 and the operational amplifier 305 can reach the node 207. This signal comprises the modulated-on useful parameterisation signal in HART® bus code. The useful signal reaches the capacity 206, which filters from the useful signal direct-current fractions that may be present.

In the useful signal's direct path by way of the capacitor 206 to the bus 103, the current-limiting element 205 and the current-limiting element 211 are bypassed, and by way of the output 209 the useful parameterisation signal 202 can be conveyed to the HARTS bus.

In the case of a short-circuit of the output 209 the capacitor 206 is discharged by way of the current-limiting element 205 and the current-limiting resistor 211, with a current that does not present a hazard in a potentially explosive environment 212. The explosion protection circuit stated in FIG. 3 is thus suitable for coupling or transmitting a useful signal or a parameterisation signal in a potentially explosive environment. The danger of a hazardous short-circuit current occurring by short circuiting the connections of the output 209 when the output 209 is connected to a measuring signal bus 103 is thus reduced.

By the resistor 211 the bus is protected against impermissibly high current from the parameterisation arrangement 105. If the capacitor 205 were to become low-resistant as a result of a defect, an impermissible current could flow from the output 310 of the operational amplifier 305 to mass, by way of the capacitor 206 and the short circuit 208, if as a result of a defect all three diodes 204 are conductive in their direction of blockage. However, concurrent failure of all three diodes is deemed to be improbable in relation to meeting explosion protection requirements.

Current limitation by means of a resistor 211 prevents the formation of an ignition-triggerable spark at the output 209 in the case of a short circuit 208. Current limitation by the resistor 205 also prevents an excessive flow of current to the bus line, which current is caused by +Vss. The bus line 103 may lead to the potentially explosive environment 104.

The parameterisation arrangement itself can partly be operated in the potentially explosive environment 212. In this arrangement the parameterisation arrangement is operated already in the potentially explosive environment 212 when the output 209 is situated in a potentially explosive environment 212. The diodes are operated for a useful signal flow in the direction of flow. For considerations of current limitation, to prevent an undesirable current from flowing from the operational amplifier output 310, operation in the direction of blockage takes place.

In addition it should be pointed out that “comprising” does not exclude other elements or steps, and “a” or “one” does not exclude a plural number. Furthermore, it should be pointed out that features or steps which have been described with reference to one of the above exemplary embodiments can also be used in combination with other features or steps of other exemplary embodiments described above. Reference signs in the claims are not to be interpreted as limitations.

1. A circuit arrangement for a field device, comprising:
an input;
an output; and
a current-limiting element,
wherein the circuit arrangement transmits a useful signal along a useful-signal path from the input to the output;
wherein the input and the output are separated from each other by a direct-current separation; and
wherein the current-limiting element is arranged outside the useful-signal path.

2. The circuit arrangement of claim 1,
wherein the output connects a bus.

3. The circuit arrangement of claim 2,
wherein the output connects to the bus, the bus including one of a HART® bus and an I2C bus.

4. The circuit arrangement of claim 1,
wherein the output includes two wires.

5. The circuit arrangement of claim 1, wherein the circuit arrangement is utilized in a potentially explosive environment.

6. The circuit arrangement of claim 1;
wherein the input includes one of a Universal Serial Bus connection and an RS232 connection.

7. The circuit arrangement of claim 1
wherein the useful signal is a parameterisation signal for the field device, the field device including one of a fill level measuring device and a pressure measuring device.

8. The circuit arrangement of claim 1, further comprising:
a capacity wired for direct-current separation of the input from the output.

9. The circuit arrangement of claim 1,
wherein the at least one current-limiting element includes an ohmic resistance.

10. The circuit arrangement of claim 9,
wherein the ohmic resistance is arranged between the useful-signal path and an electrical reference potential of the circuit arrangement.

11. The circuit arrangement of claim 1, further comprising:
at least one diode wired in the useful-signal path.

12. The circuit arrangement of claim 1, wherein the circuit arrangement is a parameterisation arrangement with an explosion protection.

13. The circuit arrangement of claim 1, wherein the useful signal is a measuring signal of the field device.

14. The circuit arrangement of claim 1,
wherein the useful-signal path includes at least one diode.

15. A field device, comprising:
a circuit arrangement of claim 1.

16. The field device of claim 15, wherein the field device is one of a fill level measuring device and a pressure measuring device.

17. A method for operating a circuit arrangement for a field device, comprising:
transmitting a useful signal along a useful-signal path from an input to an output of the circuit arrangement,
wherein the input is separated from the output by direct-current separation; and
wherein a current-limiting element is arranged in the circuit arrangement and outside the useful-signal path.
